(19) United States
(12) Patent Application Publication
(10) Pub. No.: US 2010/0129494 A1
(43) Pub. Date: May 27, 2010

(54) Yoghurt

(76) Inventors: Ellen Maria Elizabeth Mulder, Wormerveer (NL); Ulrike Schmid, Wormerveer (NL); Jeroen Monster, Wormerveer (NL)

Correspondence Address: MORGAN LEWIS & BOCKIUS LLP, 1111 PENNSYLVANIA AVENUE NW, WASHINGTON, DC, 20004, US

(21) Appl. No.: 12/597,336

(22) PCT Filed: Apr. 23, 2008
(86) PCT No.: PCT/EP08/03269

§ 371 Date: Dec. 14, 2009

(30) Foreign Application Priority Data
Apr. 24, 2007 (EP) 07251720.4

(51) Int. Cl. A23C 21/04; A23C 21/02

(52) U.S. Cl. 426/41; 426/583; 426/548; 426/573

(57) ABSTRACT

A yoghurt comprises pinolenic acid or a derivative thereof. The yoghurt may be produced by:
(a) forming an emulsion of pinolenic acid or a derivative thereof in milk;
(b) forming a mixture of milk powder, whey protein and optionally sugar with milk;
(c) combining the emulsion of (a) with the mixture of (b);
(d) optionally pasteurising the product of (c); and
(e) fermenting the optionally pasteurised product of (c) in the presence of a starter culture.

This invention relates to a yoghurt and to a process for its production.

Yoghurt (sometimes termed yogurt, or less commonly yoghourt or yogourt) is a dairy product produced by bacterial fermentation of milk. Fermentation of the milk sugar (lactose) produces lactic acid, which acts on milk protein to give yoghurt its gel-like texture and its characteristic tang. Natural, unflavored yoghurt is common; fruit, vanilla, and chocolate flavours are also popular. Yoghurts and methods for their production are described in, for example, WO 02/090527, EP-A-1749446, US20060210668 and EP-A-1749447.

The nutritional value of the diet has come under increasing scrutiny. Food supplements are often taken by individuals in order to obtain nutritional benefits. However, food supplements are typically in the form of capsules or the like and have the disadvantage that they are inconvenient in that an individual has to remember to take them. Food supplements of this type are typically not flavoured and are not attractive to many consumers.

Nutritional supplements have been incorporated into food products but the resulting food products can have an undesirable taste and the incorporation of the supplement can have a deleterious effect on the stability of the products.

Pinolenic acid (i.e., 5, 9, 12 C18:3 fatty acid, a fatty acid with 18 carbon atoms having three cis double bonds in the positions 5, 9 and 12) is present in, for example, pine out oil and fractions thereof (see J Am Oil Chem Soc 1998, 75, p. 45-50). Pinolenic acid, as a highly unsaturated fatty acid, can be expected to suffer from the problem of low oxidative stability, particularly when incorporated into foods and beverages.

FR-A-2756465 discloses the use of a concentrate with 15% pinolenic acid in various compositions, including food additives. The presence of pinolenic acid is described as providing a hypolipemic effect to the composition. There is no indication in the document as to how a food composition can be prepared and no examples are given.

EP-A-1685834 relates to the use of pinolenic acid and its derivatives for weight management by reducing the feeling of hunger and/or increasing satiety. A variety of product forms are mentioned.

WO 00/21379 relates to food substances based on substances derived from milk, which contain isomers of conjugated linoleic acid.

WO 96/025050 discloses a yoghurt containing fish oils.

It has now been found that a convenient vehicle for the consumption of pinolenic acid and its derivatives can be provided by yoghurt compositions. Surprisingly, it is possible to incorporate the pinolenic acid or derivative in these compositions in relatively high amounts and yet still achieve good oxidative stability compared to other, less saturated oils. The compositions also have good organoleptic properties (including taste and texture) and good stability. Additionally, it is possible for the yoghurt compositions to have a low calorie content and still achieve these advantages.

Accordingly, the present invention provides a yoghurt comprising pinolenic acid or a derivative thereof.

In another aspect, the invention provides a process for producing the yoghurt of the invention, which comprises:
(a) forming an emulsion of pinolenic acid or a derivative thereof in milk;
(b) forming a mixture of milk powder, whey protein and optionally sugar with milk;
(c) combining the emulsion of (a) with the mixture of (b);
(d) optionally pasteurising the product of (c); and
(e) fermenting the optionally pasteurised product of (c) in the presence of a starter culture.

A further aspect of the invention is the use of a yoghurt according to the invention for a nutritional benefit. A preferred benefit is a weight management effect, for example due to a feeling of satiety.

It has been found that yoghurts of the invention have good mouthfeel. For example, they are smooth, have an acceptable hardness, are non-chalky, non-watery, non-sandy, and have a creamy texture. Surprisingly, they have a long shelf life, with texture, appearance and colour remaining good. The yoghurts may have little or no phase separation or sedimentation, little tendency to whey off and have a good flavour which is fruity and balanced, with little or no beany off-flavours.

Moreover, despite the level of unsaturation of pinolenic acid, the yoghurts have unexpectedly good oxidative stability when compared to other oils, such as high oleic sunflower oil, sunflower oil, CLA and fish oils.

Preferably, the yoghurt comprises from 0.01 to 5% by weight pinolenic acid or derivative thereof, more preferably from 0.1 to 3% by weight pinolenic acid or derivative thereof, even more preferably from 0.2 to 1% by weight pinolenic acid or derivative thereof, such as from 0.3 to 0.8% by weight pinolenic acid or derivative thereof.

The yoghurt may further comprise linoleic acid or a derivative thereof. When the yoghurt comprises linoleic acid or a derivative thereof, the weight ratio of pinolenic acid or derivative thereof to linoleic acid or derivative thereof is preferably more than 0.15:1, even more preferably from 0.2:1 to 0.8:1.

The yoghurt preferably comprises less than 2% by weight dairy fat, more preferably less than 1% by weight dairy fat, even more preferably less than 0.5% by weight dairy fat, such as less than 0.1% by weight dairy fat.

The overall fat content of the yoghurt is preferably less than 5% by weight, more preferably from 1% to 4% by weight.

The yoghurt may comprise a flavouring substance. Flavouring substances may be used singly or in combination and include natural and artificial flavouring agents.

In one embodiment, the yoghurt has a low sugar (i.e., sucrose) content. For example, the yoghurt may comprise less than 8% by weight of sugar, preferably less than 4% by weight, most preferably from 1 to 4% by weight. Typically, the yoghurt may comprise less than 10% by weight of total sucrose, glucose and fructose, preferably less than 5% by weight, most preferably from 1 to 4% by weight. Sucrose, glucose and fructose may be specifically added or may be present as part of another component of the yoghurt. The yoghurt may comprise a sugar replacer and/or a sweetener.

Examples of suitable sweeteners are saccharin, aspartame, sucralose, neotame and acesulfame potassium, acesulfame, taumatine, cyclamate, and mixtures thereof. Preferred sweeteners are those selected from aspartame, acesulfame, sucralose and mixtures thereof.

Sugar replacers include, for example, sorbitol, mannitol, isomaltitol, xylitol, isomalt, lactitol, hydrogenated starch hydrolysates (HSH, including maltitol syrups) and mixtures thereof.

The yoghurt may contain non-fat milk solids in an amount of from 5 to 20% by weight, preferably from 11 to 18% by weight. Non-fat milk solids may be specifically added or may be present as part of another component of the yoghurt.

Typically, the milk solids will be derived from milk or products derived from milk, such as skimmed milk, skimmed milk powder and whey protein powder.

The yoghurt may comprise fruit and may be classed as a fruit yoghurt. For example, the yoghurt may comprise fruit in an amount of at least 1% by weight, or from 5 to 20% by weight, more preferably from 8 to 14% by weight on a wet basis. Wet basis refers to the fruit including any water associated with it, for example 20% by weight added apple juice corresponds to 20% by weight fruit on a wet basis. The fruit is typically admixed with the yoghurt. Examples of suitable fruits are orange, banana, pineapple, mango, passion fruit, coconut, blackberry, blueberry, apple, strawberry, cranberry, lemon, lime and mixtures thereof. Other suitable fruits can be derived from, for example, pear, peach, plum, apricot, nectarine, grape, cherry, currant, raspberry, gooseberry, elderberry, blueberry, grapefruit, mandarin, grapefruit, mango, guava, rhubarb, pomegranate, kiwi, papaya, watermelon, passion fruit, tangerine, and cantaloupe. The fruits can be in the form of juices, concentrates and, preferably, purées.

Optionally, the yoghurt comprises from 0.05 to 0.8% by weight of a thickener (i.e., a thickening agent). Suitable thickening agents include gum acacia, natural starch, modified food starches (e.g., alkenylsuccinate modified food starches), anionic polymers derived from cellulose (e.g. carboxymethylcellulose), gum ghatti, modified gum ghatti, xanthan gum, tragacanth gum, guar gum, locust bean gum, pectin, gelatine, carrageenan and mixtures thereof.

The yoghurt typically has a casein:whey weight ratio of >2, preferably from 2.5 to 3.5.

The yoghurt may additionally comprise a source of dietary fibre. Dietary fibres are complex carbohydrates resistant to digestion by mammalian enzymes, such as the carbohydrates found in plant cell walls and seaweed, and those produced by microbial fermentation.

Yoghurts of the invention optionally comprise one or more additional additives selected from colouring agents, vitamins, minerals, acidity regulators, preservatives, emulsifiers, antioxidants and mixtures thereof. Each of these materials may be a single component or a mixture of two or more components.

Examples of suitable vitamins and minerals include calcium, iron, zinc, copper, phosphorous, biotin, folic acid, pantothenic acid, iodine, vitamin A, vitamin C, vitamin B1, vitamin B2, vitamin B3, vitamin B6, vitamin B9, vitamin B12, vitamin D, vitamin E, and vitamin K. Preferably, when a vitamin or mineral is utilized the vitamin or mineral is selected from iron, zinc, folic acid, iodine, vitamin A, vitamin C, vitamin Be, vitamin B3, vitamin B6, vitamin B12, vitamin D, and vitamin E.

Acidity regulators include organic as well as inorganic edible acids. The acids can be added or be present in their undissociated form or, alternatively, as their respective salts, for example, potassium or sodium hydrogen phosphate, potassium or sodium dihydrogen phosphate salts. The preferred acids are edible organic acids which include citric acid, malic acid, fumaric acid, adipic acid, phosphoric acid, gluconic acid, tartaric acid, ascorbic acid, acetic acid, phosphoric acid, or mixtures thereof. Glucono Delta Lactone (GDL) may also be used, particularly wherein it is desired to reduce pH without introducing excessive acidic, or tart, flavour in the final composition. Citric acid is particularly useful.

Colouring agents including natural and artificial colours may optionally be used. Non-limiting examples of colouring agents include vegetable juices, riboflavin, carotenoids (e.g. β-carotene), tumeric, and lycopenes.

Preservatives may be selected from the group consisting of sorbate preservatives, benzoate preservatives, and mixtures thereof.

Antioxidants include, for example, natural or synthetic tocopherols, TBHQ, BHT, BHA, free radical scavengers, propylgallate, ascorbylesters of fatty acids and enzymes with anti-oxidant properties.

The yoghurt may contain bacteria, which may be live. Alternatively, the yoghurt may have been pasteurised. Yoghurt bacteria cultures are mostly species from Streptococcus and Lactobacillus. Preferred are the bacteria Streptococcus salivarius subsp. thermophilus, Streptococcus filant, Streptococcus lactis var. taette, Streptococcus lactis subsp. Diacetylactis and Lactobacillus delbrueckii subsp. bulgaricus. The yoghurt may comprise other lactic acid bacteria for taste or health effects (probiotics). These include, for example, Lactobacillus sp, such as L. acidophilus and Lactobacillus casei and Bifidobacterium species.

Preferably, the yoghurt of the invention is a low calorie product. For example, the yoghurt may have an energy content of less than 100 kcal/100 g, more preferably less than 80 kcal/100 g, even more preferably from 55 to 75 kcal/100 g. Calorie contents can be determined by methods well known to those skilled in the art, for example, as set out in Mullan, 2006, Labelling Determination of the Energy Content of Food: http://www.dairyscience.info/energy label.asp#3 and/or FAO Food And Nutrition Paper 77, Food energy—methods of analysis and conversion factors, Report of a Technical Workshop, Rome, 3-6 Dec. 2002, Food And Agriculture Organization of the United Nations, Rome, 2003, ISBN 92-5-105014-7.

Pinolenic acid or a derivative of pinolenic acid is an essential component of the compositions of the invention. The pinolenic acid or derivative (which term is intended to cover both pinolenic acid and derivatives when both are present) is preferably in a form selected from the free acid, salts, mono-, di- or triglycerides, or mixtures thereof.

Sources of pinolenic acid and its derivatives are available and will be known to those skilled in the art. Preferably, the pinolenic acid or derivative is in the form of pine nut oil or is derived from pine nut oil.

The pinolenic acid or derivative in the yoghurt compositions may form part of a fat composition that comprises one or more other components. The fat will typically be present homogeneously throughout the yoghurt.

In a preferred embodiment of the invention, the pinolenic acid or derivative is in the form of a fat which comprises from 12 to 45%, more preferably from 15 to 40%, such as from 16 to 35%, or from 20 to 30%, by weight pinolenic acid or derivative thereof, based on the total weight of fatty acids in the fat (calculated as free fatty acid).

Examples of other fatty acids that may be present in the fat include linoleic acid, oleic acid, taxoleic, juniperonic, sciadonic, saturated fatty acids, conjugated linoleic acid (optionally as an enriched isomer mixture) and EPA (eicosapentaenoic) and DHA (docosahexaenoic). Enrichment involves the alteration of the isomer mixture normally present (for example in a natural product), such as an alteration in the relative amounts of different geometrical isomers.

Particularly preferred fats used in yoghurt compositions of the invention are those in which the pinolenic acid or derivative is in the form of a composition which additionally comprises from 30 to 70% by weight linoleic acid or derivative thereof, based on the total weight of fatty acids in the fat (calculated as free fatty acid). Additionally or alternatively, the pinolenic acid or derivative is in the form of a fat which additionally comprises from 10 to 40% by weight oleic acid or derivative thereof, based on the total weight of fatty acids in the fat (calculated as free fatty acid). Additionally or alternatively, the pinolenic acid or derivative is in the form of a fat which additionally comprises from 1 to 15% by weight palmitic acid or derivative thereof based on the total weight of fatty acids in the fat (calculated as free fatty acid). Additionally or alternatively, the fat may comprise from 0.5 to 5 wt % of taxoleic acid or a derivative thereof.

Specific examples of fats comprising pinolenic acid or a derivative thereof that are useful in the invention include the following:
Fat compositions comprising from 10 to 35%, more preferably from 15 to 30%, by weight pinolenic acid or a derivative thereof, together with from 30 to 70% by weight linoleic acid or a derivative thereof;
Fat compositions comprising from 10 to 35%, more preferably from 15 to 30%, by weight pinolenic acid or a derivative thereof, together with from 10 to 40% by weight oleic acid or a derivative thereof;
Fat compositions comprising from 10 to 35%, more preferably from 15 to 30%, by weight pinolenic acid or a derivative thereof, together with from 1 to 15% by weight palmitic acid or a derivative thereof;
Fat compositions comprising from 10 to 35%, more preferably from 15 to 30%, by weight pinolenic acid or a derivative thereof, together with from 0.5 to 5 wt % of taxoleic acid or a derivative thereof;
Fat compositions comprising from 10 to 35° A), more preferably from 15 to 30%, by weight pinolenic acid or a derivative thereof, together with from 30 to 70% by weight linoleic acid or a derivative thereof and from 10 to 40% by weight oleic acid or a derivative thereof;
Fat compositions comprising from 10 to 35%, more preferably from 15 to 30%, by weight pinolenic acid or a derivative thereof together with from 30 to 70% by weight linoleic acid or a derivative thereof and from 1 to 15% by weight palmitic acid or a derivative thereof;
Fat compositions comprising from 10 to 35%, more preferably from 15 to 30%, by weight pinolenic acid or a derivative thereof together with from 30 to 70 by weight linoleic acid or a derivative thereof and from 0.5 to 5 wt % of taxoleic acid or a derivative thereof;
Fat compositions comprising from 10 to 35%, more preferably from 15 to 30%, by weight pinolenic acid or a derivative thereof together with from 30 to 70% by weight linoleic acid or a derivative thereof, from 1 to 15% by weight palmitic acid or a derivative thereof and from 10 to 40% by weight oleic acid or a derivative thereof; and
Fat compositions comprising from 10 to 35%, more preferably from 15 to 30%, by weight pinolenic acid or a derivative thereof, together with from 30 to 70% by weight linoleic acid or a derivative thereof, from 1 to 15% by weight palmitic acid or a derivative thereof, from 10 to 40% by weight oleic acid or a derivative thereof and from 0.5 to 5 wt % of taxoleic acid or a derivative thereof.

In these fats, the amounts of the acids or derivatives are determined as free acid based on the total fatty acid and/or derivative content of the fat. Preferably, the fatty acids are present as glycerides (more preferably triglycerides) (i.e., more than 90%, preferably more than 95%, by weight of the fatty acids are present as glycerides, more preferably triglycerides). Another preferred glyceride is the diglyceride.

In a preferred embodiment of the invention, the pinolenic acid or derivative represents at least 75% by weight of the total Δ5-polyunsaturated C18-C20 fatty acids in the fat (calculated as free fatty acid).

The pinolenic acid used in the present invention may be in the form of a free fatty acid, a derivative of pinolenic acid or mixtures thereof, including mixtures of different derivatives. Derivatives are non-toxic and edible. Derivatives of pinolenic acid, which can be used in the present invention, include salts of pinolenic acid and esters. Isomers of pinolenic acid and their derivatives can be used in the invention such as, for example, geometric isomers (having one or more trans double bonds; the double bonds in pinolenic acid are all cis). Although the pinolenic acid (and its derivatives) is preferably the 5, 9, 12 cis isomer, possible derivatives of pinolenic acid also include compounds having 18 carbon atoms and three double bonds with one or more of the three double bonds at a different position in the alkyl chain compared to pinolenic acid, including, for example, gamma linolenic acid, alpha linolenic acid, punicic acid, eleostearic acid, and their salts and alkyl esters. Suitable salts include salts with food grade cations such as sodium salts and calcium salts. Suitable esters include alkyl esters having from one to six carbon atoms. Preferred derivatives are esters and preferred esters are mono-, di- and tri-glycerides and mixtures thereof.

The other fatty acid or each of the other fatty acids in the fat can independently be present as a free fatty acid or as a derivative thereof (including a mono-, di- or triglyceride and salts, preferably glycerides), or as a mixture thereof.

A suitable source for the pinolenic acid used in the present invention is pine nut oil or concentrates thereof. For example, glycerides of pinolenic acid can be obtained from pine nut oil or concentrates thereof. Preferably, an oil or concentrate with a content of pinolenic acid or a derivative thereof of more than 15% by weight or more than 28% by weight is used (such as up to 50% by weight).

Concentrates of pinolenic acid or a derivative thereof that may be used in the present invention can be prepared by any suitable process. A suitable process is described in EP-A-1088552.

In one suitable process, an enzymic hydrolysis or glycerolysis is performed using an enzyme that can discriminate between fatty acids with a delta 5 double bond and other fatty acids. This process comprises:
i) reacting a glyceride material containing at least 2% by weight of fatty acid with cis⁵ double bond with water or glycerol in the presence of an enzyme capable of discriminating between fatty acids containing a delta 5 double bond and other fatty acids;
ii) splitting the reaction mixture into a partial glyceride rich component and a fatty acid rich component;
iii) optionally converting the partial glycerides of step ii) to free fatty acids in the presence of a suitable enzyme;
iv) optionally converting the fatty acid rich component of step ii) to triglycerides by reaction with glycerol in the presence of a suitable catalyst such as a suitable enzyme; and
v) optionally splitting the partial glyceride rich material of step ii) into components that are a) rich in monoglycerides, b) rich in diglycerides and c) rich in triglycerides and then optionally converting the partial glycerides a) and b) into triglycerides by reaction with fatty acids in the presence of a suitable enzyme.

It is preferred to use a glyceride material with a pinolenic acid content of 5 to 50 wt %, preferably 10 to 35 wt % in step i). Examples of such materials are pinolenic oils and concentrates thereof. This process produces a concentrate that contains at least 28% by weight pinolenic acid.

Enzymes suitable for use in steps i), iii), iv) and v) are lipases. Suitable commercial lipases include Candida rugosa lipase; Lipase QL; Lipase SL, Lipase OF; Rhizopus delemar; lipase; Rhizopus oryzae lipase; Geotrichum candidum B lipase; and Rhizomucor miehei lipase. Preferred enzymes for step i) are Candida rugosa lipase and Geotrichum candidum B lipase.

Suitable lipases also include Lipozyme IM (a commercial enzyme). The preferred enzyme for use in step iv) is Lipozyme M (from Rhizomucor miehei).

The fats comprising pinolenic acid or a derivative thereof that are useful in the invention may comprise one or more other fatty acids. The term fatty acid, as used herein, refers to straight chain carboxylic acids having from 12 to 24 carbon atoms and being saturated or unsaturated e.g., having 0, 1, 2 or 3 double bonds.

The pinolenic acid or derivative thereof is optionally blended with additional fatty acids or glycerides before being used in the yoghurt of the present invention. When the compositions contain one or more fatty acids and/or glycerides in addition to the pinolenic acid or derivative thereof, the additional fatty acid(s) and/or glycerides are preferably selected from liquid oils, such as soybean oil, sunflower oil, rape seed oil and cotton seed oil; cocoa butter and cocoa butter equivalents; palm oil and fractions thereof; enzymically made fats; fish oils and fractions thereof; conjugated linoleic acid and enriched isomer mixtures; gamma linolenic acid and enriched mixtures thereof; hardened liquid oils; and mixtures thereof.

The yoghurt of the invention may comprise additional, separately added fatty acids or derivatives thereof. Preferably, the yoghurt may further comprise conjugated linoleic acid (CLA) or a derivative thereof. A preferred derivative of CLA is the triglyceride.

The pinolenic acid or derivative thereof can be included in the yoghurt of the invention as an oil or in the form of a powder, such as a free flowing powder. Pinolenic acid and its derivatives in powder form can be produced, for example, by spray drying pinolenic acid or its derivatives, or a fat comprising pinolenic acid or its derivatives, with protein and/or carbohydrate, with the powder typically comprising from 50 to 90% by weight of fat. It has been found that use of the powder can give extra stability to the yoghurt.

In another aspect, the invention provides a process for producing the yoghurt of the invention. The process comprises:
(a) forming an emulsion of pinolenic acid or a derivative thereof in milk (for example a 10% by weight emulsion in milk);
(b) forming a mixture of milk powder (preferably skimmed milk powder), whey protein and optionally sugar, with milk;
(c) combining the emulsion of (a) with the mixture of (b);
(d) optionally pasteurising the product of (c) for example by heating for up to 5 minutes at greater than 90° C.; and
(e) fermenting the optionally pasteurised product of (c) in the presence of a starter culture (for example at 30 to 34° C. at pH 4 to 5).

Preferably, the resulting yoghurt is then cooled and further optional additives such as sugar syrup and/or fruit are added. The yoghurt may then be packaged, for example by filling in pots or other suitable containers and is typically cooled to below 5° C. and stored.

The listing or discussion of an apparently prior-published document in this specification should not necessarily be taken as an acknowledgement that the document is part of the state of the art or is common general knowledge.

The following non-limiting examples illustrate the invention and do not limit its scope in any way. In the examples and throughout this specification, all percentages, parts and ratios are by weight unless indicated otherwise.

### EXAMPLES

### Example 1

### Fruit Yoghurt Comprising Pinolenic Acid as Triglyceride

Formulation (%):

| | Dosage [%] | Dosage |
|---|---|---|
| Ingredient | white mass | overall [%] |
| Semi-skimmed milk 1.5% fat | 90.920 | 72.736 |
| Sugar | 4.000 | 3.2 |
| Skimmed milk powder | 1.900 | 1.52 |
| PinnoThin ™ | 1.875 | 1.5 |
| Whey protein powder (30% protein) | 1.300 | 1.04 |
| Direct starter culture | 0.005 | 0.004 |
| Sugar syrup 42% (w/w) aseptic | | 13.808 |
| Strawberry puree ° Brix aseptic | | 6.208 |

PinnoThin is a trademark of Lipid Nutrition BV and comprises, as triglycerides (in weight %):

| | |
|---|---|
| Pinolenic acid | 16 |
| Linoleic acid | 46 |
| Oleic acid | 25 |
| Palmitic acid | 4 |
| Taxoleic acid | 2 |
| Others | balance to 100 |

A 10% pre-emulsion of PinnoThin™ in milk was made by slowly mixing in PinnoThin™ to milk of 60° C. under high-shear mixing. The mixture was homogenised dual-stage at 200/50 bar and the resulting emulsion cooled to 4° C. Dry blend sugar, milk powder and whey protein was mixed with the rest of the milk. Then the PinnoThin™ pre-emulsion was added. The milk was heated to 60° C., homogenized dual-stage at 160/40 bar and heated 2 minutes at 95° C. The milk was cooled to a fermentation temperature of 32° C. Starter culture was added to the milk at 32° C. and milk was fermented till pH 4.3-4.5. The resulting yoghurt was cooled to about 20° C., stirred and sugar syrup and fruit were added to the yoghurt. Yoghurt was filled in polypropylene beakers, sealed and cooled to 4° C. Optionally sugar syrup and fruit can be replaced by commercial fruit preparations. Optionally 40 ppm sodium formiate can be added to the milk before heat treatment to promote growth of L. bulgaricus.

| | |
|---|---|
| Energy per serving of 250 g | 205 kcal/863 kJ |
| Energy per 100 g | 82 kcal/345 kJ |

The yoghurt contains 6.208% by weight fruit.

### Example 2

### Oxidative Stability of the Compositions of the Invention

A yoghurt was prepared according to the following recipe.

### Recipe:

Batch size [kg]—3.5

| | | | | | Pre- |
|---|---|---|---|---|---|
| | | Dosage | Dosage | | emulsion |
| Ingredient | Supplier | [%] | [g] | Direct | 10% |
| skimmed milk | | 88.42% | 3094.7 | 1913.45 | 1181.25 |
| skimmed milk | Grobak | 3.40% | 119 | 119 | |
| powder | | | | | |
| gelatin | Dr Oetker | 0.37% | 12.95 | 12.95 | |
| sugar | | 4.00% | 140 | 140 | |
| Pinnothin ™* | Lipid | 3.75% | 131.25 | | 131.25 |
| | Nutrition | | | | |
| starter culture | | 0.01% | 0.35 | 0.35 | |
| flavoring | Quest | 0.05% | 1.75 | 1.75 | |
| Total | | 100.00% | 3500 | 2187.5 | 1312.5 |

*pinolenic acid as triglyceride (Lipid Nutrition B. V., Wormerveer, The
Netherlands)

The milk was heated to 60° C. A 10% pre-emulsion of the oil in milk at 60° C. was prepared and the pre-emulsion homogenized at 200/50 bar. The skimmed milk powder, sugar, gelatine, and flavouring were dissolved in the remaining milk at 60° C. Then the pre-emulsion was added using the ultra-turrax. The product was heated for 10 minutes at 75-100° C. and homogenized at 160/40 bar. The product was cooled down to 38° C. and the starter culture added to the product (mix in the culture). Fermentation took place overnight (10-12 hours) in a climate cabinet at 38° C. in closed and dark plastic boxes.

All yoghurt mixtures were extracted with chloroform and methanol following this principle: To 100 g of yoghurt mixture 10 g of KCl, 100 ml chloroform and 50 ml methanol were added. The samples were put on a turax for 3 minutes at a speed of 12000 rpm. The mixture was centrifuged for 5 min at 4500 rpm. The upper layer was removed with a pipette and the lower layer together with a white pellet, which was formed in-between the layers were transferred to a filter. The solvents present in the filtrate were evaporated and the oil dried with nitrogen over night. The oil was submitted for Rancimat and Anisidine analysis.

As comparison the same yoghurt example, followed by the same extraction method was repeated with 3.75 g safflower oil. The PinnoThin™ oil and safflower oil extracted from the yoghurt mixture were compared with the pure PinnoThin™ oil and safflower oil not incorporated in a yoghurt.

| | | Oil extracted from yoghurt | | | | | Pure oil not extracted | | | | |
|---|---|---|---|---|---|---|---|---|---|---|---|
| | Time (days) | 0 | 2 | 4 | 7 | 10 | 0 | 2 | 4 | 7 | 10 |
| PinnoThin ™ | AV Anisidine | 3.1 | 5.6 | 5.7 | 5.4 | 3.5 | 3.8 | 4.4 | 7.3 | 7.1 | 6.2 |
| | value (AOCS | | | | | | | | | | |
| | Cd 18-90) | | | | | | | | | | |
| PinnoThin ™ | Rancimat | 1.2 | 3.7 | 1.7 | 1.7 | 1.2 | 3.8 | 4 | 4.1 | 3.9 | 3.8 |
| | (AOCS | | | | | | | | | | |
| | Cd 12b-92) | | | | | | | | | | |
| Safflower oil | Rancimat | 1.5 | 1.6 | 1.7 | 1.6 | 1.3 | 2.9 | 2.7 | 2.7 | 2.9 | 2.9 |
| | (AOCS | | | | | | | | | | |
| | Cd 12b-92) | | | | | | | | | | |

The results, particularly the Anisidine value, surprisingly show that the pinolenic acid is more stable towards oxidation when formulated in the yoghurt.

1. A yoghurt comprising pinolenic acid or a derivative thereof.

2. Yoghurt as claimed in claim 1, comprising from 0.1 to 3% by weight pinolenic acid or derivative thereof.

3. Yoghurt as claimed in claim 1, comprising from 0.2 to 1% by weight pinolenic acid or derivative thereof.

4. Yoghurt as claimed in claim 1, comprising from 0.3 to 0.8% by weight pinolenic acid or derivative thereof.

5. Yoghurt as claimed in claim 4, which further comprises linoleic acid or a derivative thereof.

6. Yoghurt as claimed in claim 5, wherein the weight ratio of pinolenic acid or derivative thereof to linoleic acid or derivative thereof is more than 0.15:1.

7. Yoghurt as claimed in claim 6, wherein the weight ratio of pinolenic acid or derivative thereof to linoleic acid or derivative thereof is from 0.2:1 to 0.8:1.

8. Yoghurt as claimed in claim 1 comprising less than 1% by weight dairy fat.

9. Yoghurt as claimed in claim 8 comprising less than 0.5% by weight dairy fat.

10. Yoghurt as claimed in claim 9, which comprises a flavouring substance.

11. Yoghurt as claimed in claim 1, which comprises less than 10% by weight of total sucrose, glucose and fructose.

12. Yoghurt as claimed in claim 11 comprising a sugar replacer.

13. Yoghurt as claimed in claim 11 comprising a sweetener.

14. Yoghurt as claimed in claim 13, wherein the sweetener is selected from aspartame, acesulfame, sucralose and mixtures thereof.

15. Yoghurt as claimed in claim 1, comprising non-fat milk solids in an amount of from 5 to 20% by weight.

16. Yoghurt as claimed in claim 1, which comprises fruit in an amount of from 5 to 20% by weight.

17. Yoghurt as claimed in claim 1 comprising from 0.05 to 0.8% by weight of a thickener.

18. Yoghurt as claimed in claim 1 having a casein:whey weight ratio of greater than 2.

19. Yoghurt as claimed in claim 1 having a fat content of less than 5% by weight.

20. Yoghurt as claimed in claim 1 comprising dietary fibre.

21. Yoghurt as claimed in claim 1 which further comprises conjugated linoleic acid or a derivative thereof.

22. Yoghurt as claimed in claim 1 which comprises fruit.

23. Yoghurt as claimed in claim 22 having a fruit content of at least 1% by weight.

24. Yoghurt as claimed in claim 22 having a fruit content of from 2 to 10% by weight.

25. Yoghurt as claimed in claim 1, wherein the pinolenic acid or derivative thereof is incorporated in the yoghurt in the form of a powder.

26. Yoghurt as claimed in claim 25, wherein the powder is produced by spray drying pinolenic acid or its derivatives, or a fat comprising pinolenic acid or its derivatives, with protein and/or carbohydrate.

27. Yoghurt as claimed in claim 1, wherein the pinolenic acid is in the form of a glyceride.

28. Process for producing the yoghurt of claim 1, which comprises:
(a) forming an emulsion of pinolenic acid or a derivative thereof in milk;
(b) forming a mixture of milk powder, whey protein and optionally sugar, with milk;
(c) combining the emulsion of (a) with the mixture of (b);
(d) optionally pasteurising the product of (c); and
(e) fermenting the optionally pasteurised product of (c) in the presence of a starter culture.

29. Process as claimed in claim 28, wherein the pinolenic acid or derivative thereof is incorporated in the milk in the form of a powder.

30. Process as claimed in claim 29, wherein the powder is produced by spray drying pinolenic acid or its derivatives, or a fat comprising pinolenic acid or a derivative thereof, with protein and/or carbohydrate.

31. (canceled)

32. (canceled)

33. Yoghurt as claimed in claim 9 comprising less than 0.1% by weight dairy fat.

34. Yoghurt as claimed in claim 11 which comprises from 1 to 4% by weight of total sucrose, glucose and fructose.

35. Yoghurt as claimed in claim 15 comprising 11 to 18% by weight of non-fat milk solids and 8 to 14% fruit.

36. Yoghurt as claimed in claim 18 having a casein:whey weight ratio from 2.5 to 3.5 and a fat content of from 1% to 4% by weight.

37. Yoghurt as claimed in claim 24 having a fruit content of from 3.5 to 8% by weight.

38. Yoghurt as claimed in claim 27 wherein the pinolenic acid is in the form of a triglyceride.

39. Method of obtaining a nutritional benefit in a host in need of same comprising administering to said host a yoghurt according to claim 1.

40. Method according to claim 39 wherein the benefit is a weight management effect.
